(19) United States
(12) Patent Application Publication
(10) Pub. No.: US 2017/0163478 A1
(43) Pub. Date: Jun. 8, 2017

(54) Method,electronic device and system for updating client configuration in key-value pair database

(71) Applicants: Le Holdings (Beijing) Co., Ltd., Beijing (CN); LETV SPORTS CULTURE DEVELOP(BEIJING) CO., LTD., Beijing (CN)

(72) Inventor: Ranyang Wang, Beijing (CN)

(21) Appl. No.: 15/246,444

(22) Filed: Aug. 24, 2016

Related U.S. Application Data
(63) Continuation of application No. PCT/CN2016/089478, filed on Jul. 8, 2016.

(30) Foreign Application Priority Data
Dec. 2, 2015 (CN) 201510873134.9

(51) Int. Cl. H04L 12/24; G06F 17/30; H04L 29/06

(52) U.S. Cl. CPC H04L 41/082; H04L 67/42; H04L 63/083; G06F 17/30377

(57) ABSTRACT

Disclosed are a method, an electronic device and a system for updating a client configuration in a key-value pair database. The method includes: first of all, a configuration center server configures configuration identification information in a client so that the client acquires configuration information corresponding to the configuration identification information from the configuration center server and connects with a service node indicated in the configuration information according to a connection authentication password carried in the configuration information, then determines whether update exists in the configuration information, and sends updated configuration information to the client when the update exists so that the client connects a service node indicated in the updated configuration information.

### CROSS REFERENCE TO RELATED APPLICATIONS

This application is a continuation of International Application No. PCT/CN2016/089478, filed on Jul. 8, 2016, which is based upon and claims priority to Chinese Patent Application No. 201510873134.9, filed on Dec. 2, 2015, the entire contents of all of which are incorporated herein by reference.

### TECHNICAL FIELD

The present disclosure relates to information technologies, and more particularly, to a method, an electronic device and a system for updating a client configuration in a key-value pair database.

### BACKGROUND

Redis is a memory-based key-value database, which is commonly used for constructing a high-performance and extensible distributed application system. The Redis consists of a server cluster and a client. When the Redis is used in each application server, the application server can be connected to a service node in the Redis server cluster through the client to read or write data. The client specifically can be connected to a service node in the server cluster according to configuration information pre-configured in an application server. In a process of using the Redis, an application server often needs to adjust the configuration information of the client according to a data size, a request concurrency volume and running conditions of each service node.

At present, when a client needs to adjust configuration information, generally it is required to reedit a code of an application program and restart an application server after reediting the code to complete updating the configuration information of the client. However, a process of reediting a code is relatively complex and restarting an application server takes longer time, which causes a lower update efficiency of an existing client configuration and a poorer real-time update.

### SUMMARY

The present disclosure provides a method, an electronic device and a system for updating a client configuration in a key-value pair database to solve a problem that an existing client configuration updating efficiency is lower and a real-time update is poorer.

In a first aspect, embodiments of the present disclosure provide a method for updating a client configuration in a key-value pair database, implemented by a server, including:

configuring, by a configuration center server, configuration identification information in a client so that the client acquires configuration information corresponding to the configuration identification information from the configuration center server and connects with a service node indicated in the configuration information according to a connection authentication password carried in the configuration information;

determining whether update exists in the configuration information; and

sending updated configuration information to the client when the update exists so that the client connects with the service node indicated in the configuration information according to the connection authentication password carried in the updated configuration information.

In a second aspect, embodiments of the present disclosure provide an electronic device, including: at least one processor; and a memory communicably connected with the at least one processor for storing instructions executable by the at least one processor, wherein execution of the instructions by the at least one processor causes the at least one processor to perform any methods for updating a client configuration in a key-value pair database mentioned by embodiments of the present disclosure.

In a third aspect, embodiments of the present disclosure provide an electronic device, including: at least one processor; and a memory communicably connected with the at least one processor for storing instructions executable by the at least one processor, wherein execution of the instructions by the at least one processor causes the at least one processor to:

acquire configuration information from a configuration center server according to configuration identification information configured in the configuration center server, wherein the configuration information carries a connection authentication password and service node information;

establish a connection with a service node corresponding to the service node information according to the connection authentication password;

receive updated configuration information sent by the configuration center server when update exists in the configuration information; and

carry out a service node connection according to the connection authentication password carried in the updated configuration information and the service node indicated in the updated configuration information.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of a method for updating a client configuration in a key-value pair database in accordance with some embodiments;

FIG. 2 is a flowchart of another method for updating a client configuration in a key-value pair database in accordance with some embodiments;

FIG. 3 is a structural block diagram of a configuration center server in accordance with some embodiments;

FIG. 4 is a structural block diagram of a client in accordance with some embodiments;

FIG. 5 is a structural block diagram of a system for updating a client configuration in a key-value pair database in accordance with some embodiments;

FIG. 6 is a block diagram of an entity structure of a configuration center server in accordance with some embodiments; and

FIG. 7 is a block diagram of an electronic device which is configured to perform the methods for updating a client configuration in a key-value pair database in accordance with some embodiments.

### DETAILED DESCRIPTION

To make the objectives, technical solutions, and advantages of the embodiments of the present disclosure clearer, the following clearly and completely describes the technical solutions in the embodiments of the present disclosure with combination of the accompanying drawings in the embodiments of the present disclosure. Apparently, the described embodiments are some but not all of the embodiments of the present disclosure.

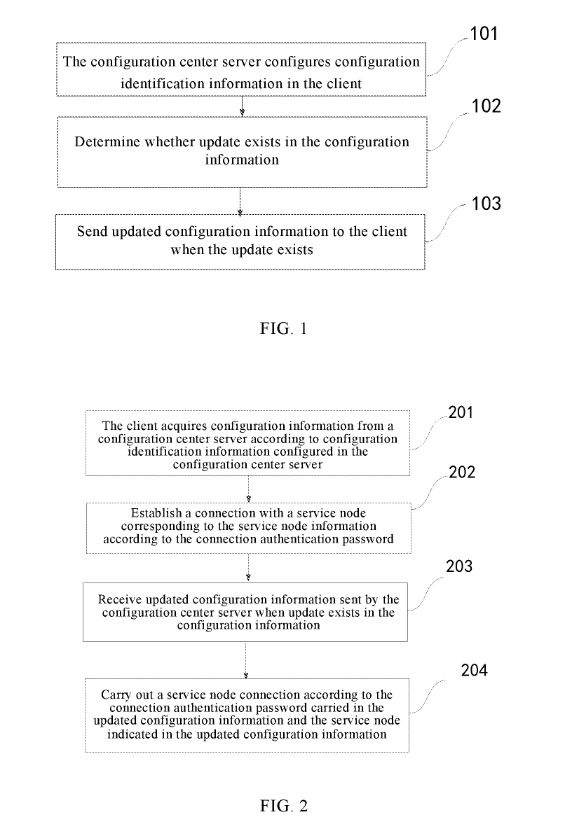

Embodiments of the present disclosure provide a method for updating a client configuration in a key-value pair database, as shown in FIG. 1, the method can be applied to a configuration center server and specifically includes following steps.

101: The configuration center server configures configuration identification information in the client.

Further, the client is allowed to acquire configuration information corresponding to the configuration identification information from the configuration center server and connect with a service node indicated in the configuration information according to a connection authentication password carried in the configuration information, where the configuration center server specifically can be constructed through Zookeeper, which is not limited in the embodiments of the present disclosure. The configuration identification information is used for uniquely identifying configuration information, each piece of configuration identification information corresponds to one client, and the configuration center server saves configuration identification information corresponding to different clients and configuration information corresponding to each piece of configuration identification information. The configuration information can save configuration identification information, identification information of a service node, a connection authentication password for carrying out an authentication to connect with a service node and functions that can be supported by the client or the like, for example, a cluster mode of a service node corresponding to the client is a master-slave mode or a Cluster mode, which are not limited in the embodiments of the present disclosure.

To the embodiments of the present disclosure, in order to ensure that the configuration information can be used by clients of different applications, a uniform format is stipulated for the configuration information, and a uniform resource identifier (URI) specification format can be used as a format of the configuration information. For example, a root path of all configuration information is /Redis. In this case, when configuration identification information is test, the configuration information is stored under a path of /Redis/test, and a content of the configuration information is as below:

Redis://127.0.0.1:6380,10.127.0.0.1:6381?mode=ms&password=hello, where Redis:// is a protocol header of the configuration information, which indicates that the configuration information is applied to a Redis client, 127.0.0.1:6380 and 10.127.0.0.1:6381 are service nodes of a Redis server cluster to which the indicated client needs to be connected, each service node consists of an IP and a port, multiple nodes are separated by separators therebetween, here a comma is used as a separator, mode=ms stipulates a cluster mode of a service node corresponding to the client, ms indicates a master-slave mode, cluster indicates a Cluster mode, and password=hello stipulates a connection authentication password used for connecting with a service node, here the connection authentication password is hello. To the embodiments of the present disclosure, security of interaction between the client and a corresponding service node can be further ensured by means of the connection authentication password carried in the configuration information.

It can be known from the foregoing configuration information having a URI specification format that in the embodiments of the present disclosure, a uniform configuration information format is employed to configure configuration information of different clients. In this way, compatibility of clients of different applications can be ensured. Meanwhile, the URI specification format is relatively simple in compiling, which can further improve the efficiency in updating a client configuration.

102: It is determined whether update exists in the configuration information.

To the embodiments of the present disclosure, Step 102 specifically can include: determining whether an update instruction corresponding to the configuration information is received. For example, when network maintenance personnel find that a fault exists in a service node in the configuration information, they can take the initiative to alter contents of the configuration information and send an update instruction to the configuration center server.

To the embodiments of the present disclosure, Step 102 specifically can further include: detecting whether update exists in the connection authentication password carried in the configuration information or whether an abnormality is present in status information corresponding to the service node indicated in the configuration information. For example, if an initial connection authentication password is hello, it is detected whether a current connection authentication password is hello. For another example, it is detected whether a service node goes wrong or whether a communications link corresponding to a service node goes wrong.

Further, it is confirmed that update exists when the update instruction corresponding to the configuration information is received, update exists in the connection authentication password, and/or an abnormality is present in the status information. To the embodiments of the present disclosure, the configuration information is updated when update exists in the connection authentication password corresponding to a service node, which can ensure a connection between the client and the service node not to be interrupted and ensure a real-time update. The configuration information is updated timely when an abnormality is present in the status information corresponding to a service node, which not only can ensure a real-time update, but also can further improve an accuracy in updating the configuration information.

103: Updated configuration information is sent to the client when the update exists.

Further, the client is allowed to connect with the service node indicated in the configuration information according to the connection authentication password carried in the updated configuration information. To the embodiments of the present disclosure, specifically the updated configuration information can be sent to the client through a callback monitoring channel established for the client.

According to a method for updating a client configuration in a key-value pair database provided by the embodiments of the present disclosure, first of all, a configuration center server configures configuration identification information in a client so that the client acquires configuration information corresponding to the configuration identification information from the configuration center server and connects with a service node indicated in the configuration information according to a connection authentication password carried in the configuration information, then determines whether update exists in the configuration information, and sends updated configuration information to the client when the update exists so that the client connects with the service node indicated in the configuration information according to the connection authentication password carried in the updated configuration information. Compared with a fact that at present when it is needed to adjust configuration information of a client, generally it is required to reedit a code of an application program and restart an application server after reediting the code, in the embodiments of the present disclosure, a configuration center server detects in real time whether updated configuration information exists and pushes the updated configuration information to the client in real time. In this way, the efficiency in updating a client configuration can be improved and a real-time update can be ensured.

Corresponding to the foregoing method, embodiments of the present disclosure further provide another method for updating a client configuration in a key-value pair database, as shown in FIG. 2, the method can be applied to a client, specifically including following steps.

201: The client acquires configuration information from a configuration center server according to configuration identification information configured in the configuration center server.

The configuration information carries a connection authentication password and service node information. The configuration identification information is used for uniquely identifying configuration information, each piece of configuration identification information corresponds to one client, and the configuration center server saves configuration identification information corresponding to different clients and configuration information corresponding to each piece of configuration identification information. The configuration information can save configuration identification information, identification information of a service node, a connection authentication password for carrying out an authentication to connect with a service node and functions that can be supported by the client or the like, which are not limited in the embodiments of the present disclosure.

To the embodiments of the present disclosure, Step 201 specifically can include: establishing callback monitoring between the client and the configuration center server. The configuration information is acquired from the configuration center server by invoking the callback monitoring.

202: A connection is established with a service node corresponding to the service node information according to the connection authentication password.

Before Step 202, the embodiments of the present disclosure further can include: detecting whether a format corresponding to the configuration information conforms to the URI specification format. In this case, Step 202 specifically can include: establishing a connection with a service node corresponding to the service node information according to the connection authentication password if the format conforms to the URI specification format. The configuration information is deleted if format does not conform to the URI specification format. Before establishing a connection with the service node corresponding to the service node information, by detecting whether a format corresponding to the configuration information conforms to the URI specification format, it can be ensured that the client can establish an effective connection according to the configuration information, thereby avoiding processing unrecognizable configuration information and avoiding waste of system resources.

203: Updated configuration information sent by the configuration center server is received when update exists in the configuration information.

Specifically, the pre-established callback monitoring can be invoked to receive the updated configuration information sent by the configuration center server.

204: A service node connection is carried out according to the connection authentication password carried in the updated configuration information and the service node indicated in the updated configuration information.

It is to be noted that reference can be made to corresponding description in FIG. 1 for concept explanation of nouns involved with the embodiments of the present disclosure, which is not unnecessarily elaborated any more herein.

According to another method for updating a client configuration in a key-value pair database provided by the embodiments of the present disclosure, first of all, the client acquires configuration information from a configuration center server according to configuration identification information configured in the configuration center server, then establishes a connection with a service node corresponding to the service node information according to the connection authentication password, receives updated configuration information sent by the configuration center server when update exists in the configuration information, and finally carries out a service node connection according to the connection authentication password carried in the updated configuration information and the service node indicated in the updated configuration information. Compared with a fact that at present when it is needed to adjust configuration information of a client, generally it is required to reedit a code of an application program and restart an application server after reediting the code, in the embodiments of the present disclosure, a configuration center server detects in real time whether updated configuration information exists and pushes the updated configuration information to the client in real time. In this way, the efficiency in updating a client configuration can be improved and a real-time update can be ensured.

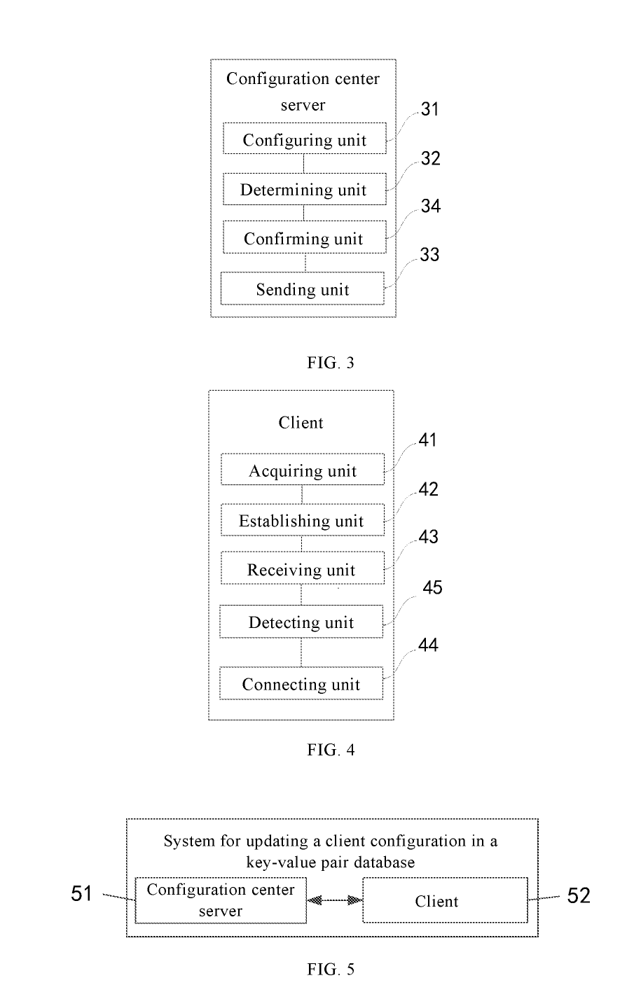

Further, as a concrete implementation of the method as shown in FIG. 1, embodiments of the present disclosure provide a configuration center server, as shown in FIG. 3, the configuration center server includes: a configuring unit 31, a determining unit 32 and a sending unit 33.

The configuring unit 31 is configured to configure configuration identification information in a client so that the client acquires configuration information corresponding to the configuration identification information from the configuration center server and connects with a service node indicated in the configuration information according to a connection authentication password carried in the configuration information.

The determining unit 32 is configured to determine whether update exists in the configuration information.

The sending unit 33 is configured to send updated configuration information to the client when the update exists so that the client connects with the service node indicated in the configuration information according to a connection authentication password carried in the updated configuration information.

The determining unit 32 is specifically configured to determine whether an update instruction corresponding to the configuration information is received, and/or detect whether update exists in the connection authentication password carried in the configuration information or whether an abnormality is present in status information corresponding to the service node indicated in the configuration information.

Further, the configuration center server further includes:

a confirming unit 34, configured to confirm update exists when the update instruction corresponding to the configuration information is received, the update exists in the connection authentication password, and/or an abnormality is present in the status information.

A format corresponding to the configuration information is a URI specification format.

It is to be noted that reference can be made to corresponding description in FIG. 1 for other corresponding description of various functional units involved with a configuration center server provided by embodiments of the present disclosure, which is not unnecessarily elaborated any more herein.

The configuration center server provided by embodiments of the present disclosure first of all configures configuration identification information in a client so that the client acquires configuration information corresponding to the configuration identification information from the configuration center server and connects with a service node indicated in the configuration information according to a connection authentication password carried in the configuration information, then determines whether update exists in the configuration information, and sends updated configuration information to the client when the update exists so that the client connects with the service node indicated in the configuration information according to the connection authentication password carried in the updated configuration information. Compared with a fact that at present when it is needed to adjust configuration information of a client, generally it is required to reedit a code of an application program and restart an application server after reediting the code, in the embodiments of the present disclosure, a configuration center server detects in real time whether updated configuration information exists and pushes the updated configuration information to the client in real time. In this way, the efficiency in updating a client configuration can be improved and a real-time update can be ensured.

Further, as a concrete implementation of the method as shown in FIG. 2, embodiments of the present disclosure provide a client, as shown in FIG. 4, the client includes: an acquiring unit 41, an establishing unit 42, a receiving unit 43 and a connecting unit 44.

The acquiring unit 41 is configured to acquire configuration information from a configuration center server according to configuration identification information configured in the configuration center server, where the configuration information carries a connection authentication password and service node information.

The establishing unit 42 is configured to establish a connection with a service node corresponding to the service node information according to the connection authentication password.

The receiving unit 43 is configured to receive updated configuration information sent by the configuration center server when update exists in the configuration information.

The connecting unit 44 is configured to carry out a service node connection according to the connection authentication password carried in the updated configuration information and the service node indicated in the updated configuration information.

Further, the client further includes a detecting unit 45.

The detecting unit 45 is configured to detect whether a format corresponding to the configuration information conforms to a URI specification format.

The connecting unit is specifically configured to establish a connection with a service node corresponding to the service node information according to the connection authentication password when the format conforms to the URI specification format.

It is to be noted that reference can be made to corresponding description in FIG. 2 for other corresponding description of various functional units involved with a client provided by the embodiments of the present disclosure, which is not unnecessarily elaborated any more herein.

The client provided by the embodiments of the present disclosure first of all acquires configuration information from a configuration center server according to configuration identification information configured in the configuration center server, then establishes a connection with a service node corresponding to the service node information according to the connection authentication password, receives updated configuration information sent by the configuration center server when update exists in the configuration information, and finally carries out a service node connection according to the connection authentication password carried in the updated configuration information and the service node indicated in the updated configuration information. Compared with a fact that at present when it is needed to adjust configuration information of a client, generally it is required to reedit a code of an application program and restart an application server after reediting the code, in the embodiments of the present disclosure, a configuration center server detects in real time whether updated configuration information exists and pushes the updated configuration information to the client in real time. In this way, the efficiency in updating a client configuration can be improved and a real-time update can be ensured.

Still further, as a concrete implementation of the method as shown in FIG. 1 or FIG. 2, embodiments of the present disclosure provide a system for updating a client configuration in a key-value pair database, as shown in FIG. 5, the system includes a configuration center server 51 and a client 52.

The configuration center server 51 is configured to configure configuration identification information in the client.

The client 52 is configured to acquire configuration information corresponding to the configuration identification information from the configuration center server and connect with a service node indicated in the configuration information according to a connection authentication password carried in the configuration information.

The configuration center server 51 is further configured to determine whether update exists in the configuration information and send updated configuration information to the client when update exists in the configuration information.

The client 52 is further configured to carry out a service node connection according to the connection authentication password carried in the updated configuration information and the service node indicated in the updated configuration information.

It is to be noted that reference can be made to corresponding description in FIG. 1 or FIG. 2 for other corresponding description of the configuration center server and the client involved with the system for updating a client configuration in a key-value pair database provided by the embodiments of the present disclosure, which is not unnecessarily elaborated any more herein.

According to the system for updating a client configuration in a key-value pair database provided by the embodiments of the present disclosure, first of all, a configuration center server configures configuration identification information in a client so that the client acquires configuration information corresponding to the configuration identification information from the configuration center server and connects with a service node indicated in the configuration information according to a connection authentication password carried in the configuration information, then determines whether update exists in the configuration information, and sends updated configuration information to the client when the update exists so that the client connects with the service node indicated in the updated configuration information. Compared with a fact that at present when it is needed to adjust configuration information of a client, generally it is required to reedit a code of an application program and restart an application server after reediting the code, in the embodiments of the present disclosure, a configuration center server detects in real time whether updated configuration information exists and pushes the updated configuration information to the client in real time. In this way, the efficiency in updating a client configuration in Redis can be improved and a real-time update can be ensured.

It is to be noted that in allusion to the foregoing configuration center server, functions of each unit module used in the embodiments of the present disclosure can be implemented through a hardware processor.

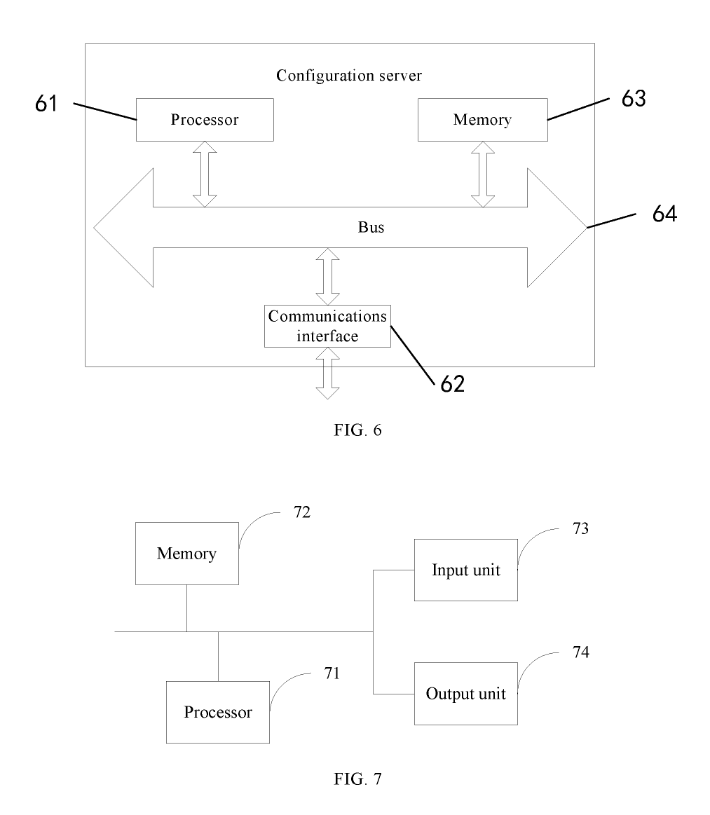

Exemplarily, as shown in FIG. 6, which illustrates a schematic diagram of an entity structure of a configuration center server according to embodiments of the present disclosure, the configuration center server can include: a processor 61, a communications interface 62, a memory 63 and a bus 64, where the processor 61, the communications interface 62 and the memory 63 complete communications among each other through the bus 64. The communications interface 62 can be configured to implement information transmission between the configuration center server and the client. The processor 61 can invoke a logic instruction in the memory 63 to execute the following method: a configuration center server configures configuration identification information in a client so that the client acquires configuration information corresponding to the configuration identification information from the configuration center server and connects with a service node indicated in the configuration information according to a connection authentication password carried in the configuration information, then determines whether update exists in the configuration information, and sends updated configuration information to the client when the update exists so that the client connects with the service node indicated in the configuration information according to the connection authentication password carried in the updated configuration information.

In addition, when a logic instruction in the foregoing memory 63 can be implemented in the form of a software functional unit and is sold or used as an independent product, the logic instruction can be stored in a computer-readable storage medium. Based on such understanding, the essence of or a part of the technical solutions in the present disclosure (that is, the part making contributions over prior arts) may be embodied as software products. The computer software products may be stored in a storage medium including instructions which enable a computer device (for example, a personal computer, a server or a network device, and so on) to perform whole or a part of the steps in the methods according to various embodiments of the present disclosure. The above mentioned storage medium may include various mediums capable of storing program codes, for example, a USB flash drive, a mobile hard disk drive, a read only memory (ROM), a random access memory (RAM), a magnetic disk or an optical disk, and so on.

Further, an embodiment of the present disclosure further provides a non-transitory computer-readable storage medium storing executable instructions, which can be executed by an electronic device to perform any methods for updating a client configuration in a key-value pair database mentioned by embodiments of the present disclosure.

FIG. 7 is a block diagram of an electronic device which is configured to perform the methods for updating a client configuration in a key-value pair database according to an embodiment of the present disclosure. As shown in FIG. 7, the device includes:

one or more processors 71 and memory 72. A processor 71 is showed in FIG. 7 for an example.

Device which is configured to perform the methods for updating a client configuration in a key-value pair database can also include: input unit 73 and output unit 74.

Processor 71, memory 72, input unit 73 and output unit 74 can be connected by BUS or other methods, and BUS connecting is showed in FIG. 7 for an example.

Memory 72 can be used for storing non-transitory software program, non-transitory computer executable program and modules as a non-transitory computer-readable storage medium, such as corresponding program instructions/modules for the methods for updating a client configuration in a key-value pair database mentioned by embodiments of the present disclosure (such as shown in FIG. 3, configuring unit 31, determining unit 32, sending unit 33 and confirming unit 34). Processor 71 performs kinds of functions and updating a client configuration in a key-value pair database of the electronic device by executing non-transitory software program, instructions and modules which are stored in memory 72, thereby realizes the methods for updating a client configuration in a key-value pair database mentioned by embodiments of the present disclosure.

Memory 72 can include program storage area and data storage area, thereby the operating system and applications required by at least one function can be stored in program storage area and data created by using the device for updating a client configuration in a key-value pair database can be stored in data storage area. Furthermore, memory 72 can include high speed Random-access memory (RAM) or non-volatile memory such as magnetic disk storage device, flash memory device or other non-volatile solid state storage devices. In some embodiments, memory 72 can include long-distance setup memories relative to processor 71, which can communicate with the device for updating a client configuration in a key-value pair database by networks. The examples of said networks are including but not limited to Internet, Intranet, LAN, mobile Internet and their combinations.

Input unit 73 can be used to receive inputted number, character information and key signals causing user configures and function controls of the device for updating a client configuration in a key-value pair database. Output unit 74 can include a display screen or a display device.

The said module or modules are stored in memory 72 and perform the methods for updating a client configuration in a key-value pair database when executed by one or more processors 71.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

What is claimed is:

1. A method for updating a client configuration in a key-value pair database, implemented by a server, comprising:
configuring, by a configuration center server, configuration identification information in a client so that the client acquires configuration information corresponding to the configuration identification information from the configuration center server and connects with a service node indicated in the configuration information according to a connection authentication password carried in the configuration information;
determining whether update exists in the configuration information; and
sending updated configuration information to the client when the update exists so that the client connects with the service node indicated in the configuration information according to the connection authentication password carried in the updated configuration information.

2. The method according to claim 1, wherein the determining whether update exists in the configuration information comprises:
determining whether an update instruction corresponding to the configuration information is received; or
detecting whether update exists in the connection authentication password carried in the configuration information or whether an abnormality is present in status information corresponding to the service node indicated in the configuration information.

3. The method according to claim 2, further comprising:
confirming the update exists when the update instruction corresponding to the configuration information is received, the update exists in the connection authentication password, or the abnormality is present in the status information.

4. The method according to claim 1, wherein a format corresponding to the configuration information is a URI specification format.

5. An electronic device, comprising:
at least one processor; and
a memory communicably connected with the at least one processor for storing instructions executable by the at least one processor, wherein execution of the instructions by the at least one processor causes the at least one processor to:
configure configuration identification information in a client so that the client acquires configuration information corresponding to the configuration identification information from the configuration center server and connects with a service node indicated in the configuration information according to a connection authentication password carried in the configuration information;
determine whether update exists in the configuration information; and
send updated configuration information to the client when the update exists so that the client connects with the service node indicated in the configuration information according to the connection authentication password carried in the updated configuration information.

6. The electronic device according to claim 5, wherein the determining whether update exists in the configuration information comprises:
determining whether an update instruction corresponding to the configuration information is received; or
detecting whether update exists in the connection authentication password carried in the configuration information or whether an abnormality is present in status information corresponding to the service node indicated in the configuration information.

7. The electronic device according to claim 6, wherein the instructions are executed to cause the at least one processor to:
confirm the update exists when the update instruction corresponding to the configuration information is received, the update exists in the connection authentication password, or the abnormality is present in the status information.

8. The electronic device according to claim 5, wherein a format corresponding to the configuration information is a URI specification format.

9. An electronic device, comprising:
at least one processor; and
a memory communicably connected with the at least one processor for storing instructions executable by the at least one processor, wherein execution of the instructions by the at least one processor causes the at least one processor to:
acquire configuration information from a configuration center server according to configuration identification information configured in the configuration center server, wherein the configuration information carries a connection authentication password and service node information;
establish a connection with a service node corresponding to the service node information according to the connection authentication password;
receive updated configuration information sent by the configuration center server when update exists in the configuration information; and
carry out a service node connection according to the connection authentication password carried in the updated configuration information and the service node indicated in the updated configuration information.

10. The electronic device according to claim 9, wherein before the establishing a connection with a service node corresponding to the service node information according to the connection authentication password, the instructions are executed to cause the at least one processor to:
detect whether a format corresponding to the configuration information conforms to a URI specification format; and
the establishing a connection with a service node corresponding to the service node information according to the connection authentication password comprises:
establishing a connection with the service node corresponding to the service node information according to the connection authentication password when the format corresponding to the configuration information conforms to the URI specification format.
